(19) United States
(12) Patent Application Publication
(10) Pub. No.: US 2025/0196088 A1
(43) Pub. Date: Jun. 19, 2025

(54) CONTINUOUS PRODUCTION SYSTEM

(71) Applicant: Panasonic Intellectual Property Management Co., Ltd., Osaka (JP)

(72) Inventors: Kiyoshi HASHIMOTODANI, Kyoto (JP); Yusuke KITAGAWA, Hyogo (JP); Toshihiro SAKAMOTO, Osaka (JP); Yuki KUSHIDA, Kyoto (JP); Yoshiki YAMADA, Osaka (JP)

(21) Appl. No.: 18/844,858

(22) PCT Filed: Mar. 10, 2023
(86) PCT No.: PCT/JP2023/009229

§ 371 Date: Sep. 6, 2024

(30) Foreign Application Priority Data
Mar. 11, 2022 (JP) 2022-038588

(51) Int. Cl. B01J 19/18; B01J 19/00

(52) U.S. Cl. CPC B01J 19/1825; B01J 19/0013; B01J 19/002; B01J 2219/00202; B01J 2219/00225; B01J 2219/00236

(57) ABSTRACT

A continuous production system according to an aspect of the present disclosure includes a continuous reactor, a supply path connected to the continuous reactor, a guide path connected to the continuous reactor, a measuring apparatus configured to acquire information on a substance moving in the continuous reactor or in the guide path, and a controller configured to perform control based on the information. The information is electric impedance of the substance or a property of the substance, the property being derived from the electric impedance.

### TECHNICAL FIELD

The present disclosure relates to a continuous production system and specifically relates to a continuous production system for obtaining a product by using a continuous reactor.

### BACKGROUND ART

Patent Literature 1 discloses a continuous manufacturing system that continuously manufactures a product from a powder of a raw material, the system comprising: a first processing device that performs first processing on the powder of the raw material; a second processing device that performs second processing on the powder on which the first processing device has performed the first processing; and an inspection and sorting device including an inspection chamber into which powder sent from the first processing device flows from upstream, wherein when a prescribed amount of the powder has accumulated in the inspection chamber, the inspection and sorting device inspects the powder inside the inspection chamber after blocking a path connecting the first processing device to the inspection chamber; when the inspection ends, the inspection and sorting device removes the blocking after discharging the powder from inside the inspection chamber; and the inspection and sorting device includes a sensor that senses whether or not the powder that has accumulated in the inspection chamber has reached a prescribed height, and the inspection and sorting device performs the inspection when the sensor senses that the prescribed amount of the powder has accumulated in the inspection chamber. Patent Literature 1 further discloses that in the inspection and sorting device, an inspection is performed on the raw material by using a spectroscopic analyzer when a raw material has sent from an apparatus connected upstream of the inspection and sorting device and a prescribed amount of the raw material has accumulated in the inspection chamber, and the raw material after the inspection is sent to a flow path according to an inspection result.

### CITATION LIST

### Patent Literature

Patent Literature 1: JP 6578456 B1

### SUMMARY OF INVENTION

It is an object of the present disclosure to provide a continuous production system configured to, for obtaining a product by using a continuous reactor, check a property of the product during production of the product and use a check result.

A continuous production system according to an aspect of the present disclosure includes: a continuous reactor; a supply path connected to the continuous reactor; a guide path connected to the continuous reactor; a measuring apparatus configured to acquire information on a substance moving in the continuous reactor or in the guide path; and a controller configured to perform control based on the information, the information being electric impedance of the substance or a property of the substance, the property being derived from the electric impedance.

### BRIEF DESCRIPTION OF DRAWINGS

FIG. 1 is a schematic diagram of an embodiment of the present disclosure;

FIG. 2 is a schematic sectional view of a main part of the embodiment;

FIG. 3 is a flowchart of an operation example of a controller of the embodiment;

FIG. 4 is a graph of an example of a time-dependent change in a parameter which is information acquired by a measuring apparatus when control is performed by the controller of the embodiment; and

FIG. 5 is a schematic diagram of an operation example of the embodiment.

### DESCRIPTION OF EMBODIMENTS

Continuous production is a production method including, to sequentially process a raw material or the like in a step to produce a product, connecting, at an inlet side of a facility for the step, a raw material or the like to be next processed to a preceding raw material or the like by any method such that the raw material or the like is processed constantly in the facility without a cut and the product is thus continuously produced. Note that the continuous production includes not only processing a preceding raw material or the like and a next raw material or the like which have been physically connected to each other but also consecutively processing, one after another, a preceding raw material or the like and a next raw material or the like which are not physically connected to each other. The continuous production is performed in casting facilities, rolling facilities, plating facilities, and the like, for example, in metal material-related manufacturing premise and is also typical in scenes such as chemical synthesis, organic synthesis, polymer synthesis, fine chemical synthesis, pharmaceutical synthesis, and bio-pharmaceutical production.

When a product is produced by using a continuous reactor, the product is continuously produced, and therefore, even when the product is defective, the defective product is continuously produced and may be mixed with normal products. In such a case, a large amount of product has to be, for example, discarded as a defective product.

Therefore, the inventors considered measuring the condition of a product or the like continuously produced and changing, for example, a reaction condition based on a measurement result.

When, however, the inspection by using the spectroscopic analyzer as disclosed in Patent Literature 1 is performed, a substance as a target of the measurement has to once be stored, and therefore, promptly measuring the substance which is continuously moving is difficult, and there are restrictions in connection with, for example, optical transparency, on the target of the measurement.

Therefore, the inventors continued with research and development intended to, for obtaining a product by using a continuous reactor, check a property of the product during production of the product and use a check result, and the inventors have completed the present disclosure.

Note that the process of the development described above should not be construed as limiting the contents of the present disclosure.

An embodiment of the present disclosure will be described below. A continuous production system according to the present embodiment includes a continuous reactor 1, a supply path 2 connected to the continuous reactor 1, a guide path 3 connected to the continuous reactor 1, a measuring apparatus 4 configured to acquire information on a substance moving in the continuous reactor 1 or in the guide path 3, and a controller 5 configured to perform control based on the information. The information acquired by the measuring apparatus 4 is electric impedance of the substance or a property of the substance, the property being derived from the electric impedance.

The present embodiment enables the information on the substance moving in the continuous reactor 1 or in the guide path 3, to be promptly obtained and enables the controller 5 to perform the control based on the information. This enables, for obtaining a product by using a continuous reactor 1, a property of the product to be checked during production of the product and enables a check result to be used.

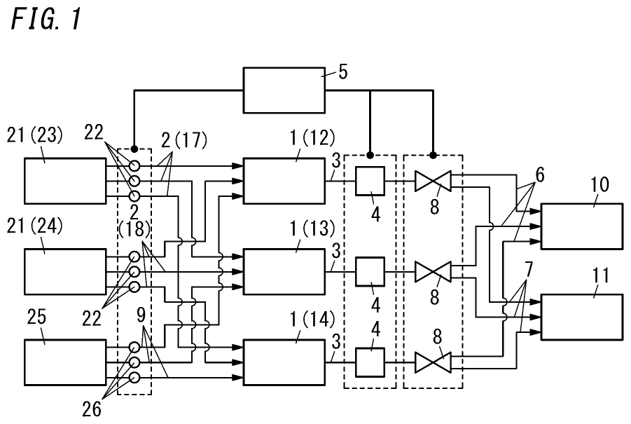

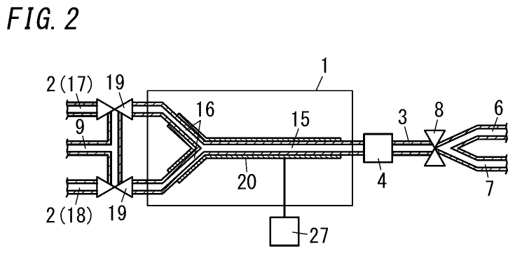

FIGS. 1 and 2 show an example of the configuration of the continuous production system according to the present embodiment. The continuous production system includes the continuous reactor 1, the supply path 2, the guide path 3, the measuring apparatus 4, and the controller 5 as described above. Moreover, in the example shown in FIGS. 1 and 2, the continuous production system includes a temperature adjusting mechanism, a raw material supplying mechanism, a first branch path 6, a second branch path 7, a switching valve 8, a cleaning flow path 9, a product tank 10, a waste product tank 11, and a detergent supplying mechanism.

The continuous reactor 1 in the continuous production system according to the present embodiment is a tube-type reactor. In the present embodiment, the continuous production system includes three continuous reactors 1. The three continuous reactors 1 are hereinafter respectively referred to also as a first reactor 12, a second reactor 13, and a third reactor 14 Note that the structure of each continuous reactor 1 is not limited, and, for example, each continuous reactor 1 may be a continuous tank-type reactor. Moreover, the number of continuous reactors 1 is not limited. One continuous reactor 1 may be provided, or a plurality of continuous reactors 1 may be provided.

Each continuous reactor 1 has a starting end to which the supply path 2 and the cleaning flow path 9 are connected. Each continuous reactor 1 has a terminating end to which the guide path 3 is connected. The guide path 3 has a terminating end to which the first branch path 6 and the second branch path 7 are connected.

Each continuous reactor 1 includes a main part 15 having a tubular shape and two introduction parts 16 branched from a starting end of the main part 15 and each having a tubular shape. To each continuous reactor 1, two supply paths 2 are connected. The two supply paths 2 are respectively referred to also as a first supply path 17 and a second supply path 18. The two introduction parts 16 have respective starting ends to which the first supply path 17 and the second supply path 18 are connected. The cleaning flow path 9 has a terminating end which branches into two portions, and the two portions are connected to the respective starting ends of the two introduction parts 16. The starting end of each of the introduction parts 16 is provided with a switching valve 19, and the switching valve 19 selectively connects the each of the introduction parts 16 to the supply path 2 or the cleaning flow path 9.

The main part has a terminating end to which a starting end of the guide path 3 is connected, and as described above, to the terminating end of the guide path 3, a starting end of the first branch path 6 and a starting end of the second branch path 7 are connected. The terminating end of the guide path 3 is provided with the switching valve 8 described above. The switching valve 8 selectively connects the guide path 3 to the first branch path 6 or the second branch path 7.

In the present embodiment, the measuring apparatus 4 acquires the information on the substance moving in the guide path 3. Note that as described above, the measuring apparatus 4 may acquire information on the substance moving in the continuous reactor 1. The information on the substance is electric impedance or a property of the substance, the property being derived from the electric impedance. The measuring apparatus 4 includes a plurality of electrodes disposed at, for example, the guide path 3 or the continuous reactor 1 and an electric impedance analyzer configured to measure electric impedance between the plurality of electrodes. The plurality of electrodes are, for example, exposed in the guide path 3 or in the continuous reactor 1. Moreover, as long as a circuit including the electrodes and the substance in the guide path 3 or in the continuous reactor 1 is formed and the electric impedance are measurable by using the electrodes, the electrodes do not have to be exposed in the guide path 3 or in the continuous reactor 1. The property of the substance derived from the electric impedance will be described later.

A substance to be measured by the measuring apparatus 4 is a product produced by the continuous reactor 1. Moreover, in the present embodiment, a detergent moving in the continuous reactor 1 or in the guide path 3 can be the substance to be measured.

In the present embodiment, the temperature adjusting mechanism includes a Peltier module 20 disposed in the continuous reactor 1 and a power supply device 27 configured to supply a current to the Peltier module 20. Therefore, allowing a current to flow from the power supply device 27 to the Peltier module 20 heats or cools the continuous reactor 1, thereby adjusting the temperature of the continuous reactor 1. Note that the configuration of the temperature adjusting mechanism is not limited to this example as long as it can adjust the temperature of the continuous reactor 1. For example, the temperature adjusting mechanism may include, for example, a heater, such as electric heating wires or a water bath, and a cooler other than the Peltier module 20.

In the present embodiment, the raw material supplying mechanism includes a raw material tank 21 and a valve 22. The raw material tank 21 stores a raw material to be supplied to the continuous reactor 1. In the present embodiment, the raw material supplying mechanism includes two raw material tanks 21, and respective raw materials different from each other are stored in the two raw material tanks 21. The two raw material tanks 21 are hereinafter respectively referred to as a first raw material tank 23 and a second raw material tank 24. To the first raw material tank 23, starting ends of the first supply paths 17 connected to the respective continuous reactors 1 are connected. Therefore, the raw material stored in the first raw material tank 23 can be supplied through the first supply paths 17 to the respective continuous reactor 1.

To the second raw material tank 24, starting ends of the second supply paths 18 connected to the respective continuous reactors 1 are connected. Therefore, the raw material stored in the second raw material tank 24 can be supplied through the second supply paths 18 to the respective continuous reactors 1. Each supply path 2 is provided with the valve 22 described above. The 22 is, for example, an on-off valve or an adjustment valve. When the valve 22 opens, the raw material in the raw material tank 21 is supplied through the supply path 2 to the continuous reactor 1. Note that as long as the raw material can be supplied trough the supply path 2 to the continuous reactor 1, the configuration of the raw material supplying mechanism is not limited to the example described above. For example, the raw material supplying mechanism may include a driving device, such as a pump or a feeder, for moving the raw material in the supply path 2.

The detergent supplying mechanism includes a detergent tank 25 and a valve 26. The detergent tank 25 stores a detergent to be supplied to the continuous reactors 1. To the detergent tank 25, starting ends of the cleaning flow paths 9 connected to the respective continuous reactors 1 are connected. Therefore, the detergent stored in the detergent tank 25 can be supplied through the cleaning flow paths 9 to the respective continuous reactors 1. Each cleaning flow path 9 is provided with the valve 26 described above. The valve 26 is, for example, an on-off valve or an adjustment valve. When the valve 26 opens, the detergent in the detergent tank 25 can be supplied through the cleaning flow path 9 to the continuous reactor 1. Note that as long as the detergent can be supplied through the cleaning flow path 9 to the continuous reactor 1, the configuration of the detergent supplying mechanism is not limited to the example above. For example, the detergent supplying mechanism may include a driving device, such as a pump or a feeder, for moving the detergent in each cleaning flow path 9.

The first branch paths 6 connected to the respective continuous reactors 1 have terminating ends connected to the product tank 10, and The second branch paths 7 connected to the respective continuous reactors 1 have terminating ends connected to the waste product tank 11.

The controller 5 performs the control based on the information acquired by the measuring apparatus 4 as described above. The contents of the control performed by the controller 5 are not particularly limited. The controller 5 can perform control of an apparatus included in, for example, a continuous production system. Note that the controller 5 may perform control of a different apparatus from the apparatus included in the continuous production system.

The controller 5 includes a microcomputer including, for example, one or more processors and memory. In other words, the controller 5 is implemented by a computer system including one or more processors and memory, and the one or more processors execute a program stored in the memory, and thereby, the computer system functions as the controller 5. Here, the program is stored in the memory of the controller 5 in advance but may be provided over a communications network, such as the Internet or may be provided by a non-transitory recording medium such as a memory card storing the program. A computer program product may be used which loads the program via the computer system and executes a program instruction causing the computer system to implement a function as the controller 5. The controller 5 is not limited to the microcomputer but may be, for example, an integrated circuit, such as an application-specific integrated circuit (ASIC), including a logic circuit.

The apparatus controlled by the controller 5 includes at least one selected from the group consisting of, for example, the temperature adjusting mechanism, the raw material supplying mechanism, the switching valve 8, and the detergent supplying mechanism described above.

When the apparatus controlled by the controller 5 includes the temperature adjusting mechanism, that is, when the control by the controller 5 includes controlling operation of the temperature adjusting mechanism, the controller 5 can, for example, based on the information acquired by the measuring apparatus 4, and in accordance with the condition of the substance corresponding to the information, cause the temperature adjusting mechanism to operate to perform control, such as maintaining or changing, the temperature of the continuous reactor 1.

That is, for example, when the condition of the substance corresponding to the information acquired by the measuring apparatus 4 is a normal condition, the controller 5 causes the temperature adjusting mechanism to operate such that the temperature of the continuous reactor 1 is not changed but is maintained. Further, for example, when the condition of the substance is not normal but if the situation is such that the condition of the substance can become normal by increasing the temperature of the continuous reactor 1, the controller 5 causes the temperature adjusting mechanism to operate such that the temperature of the continuous reactor 1 is increased. Furthermore, for example, when the condition of the substance is not normal but if the situation is such that the condition of the substance can become normal by reducing the temperature of the continuous reactor 1, the controller 5 causes the temperature adjusting mechanism to operate such that the temperature of the continuous reactor 1 is reduced. Therefore, the controller 5 can cause, based on the information on the substance acquired by the measuring apparatus 4, the temperature adjusting mechanism to perform the operation corresponding to the information. Thus, the temperature of the continuous reactor 1 can be adjusted such that the continuous reactor 1 produces a normal product.

When the apparatus controlled by the controller 5 includes the raw material supplying mechanism, that is, when the control by the controller 5 includes controlling the operation of the raw material supplying mechanism, the controller 5 can, for example, based on the information acquired by the measuring apparatus 4, and in accordance with the condition of the substance corresponding to the information, cause the raw material supplying mechanism to operate to perform control, such as maintaining or changing, the supply volume of the raw material to be supplied to the continuous reactor 1. That is, for example, when the condition of the substance corresponding to the information acquired by the measuring apparatus 4 is the normal condition, the controller 5 does not change but maintains the supply volume of the raw material to be supplied to the continuous reactor 1. Further, for example, when the condition of the substance is not normal but if the situation is such that the condition of the substance can become normal by increasing the supply volume of the raw material to be supplied to the continuous reactor 1, the controller 5 causes the raw material supplying mechanism to operate such that the supply volume of the raw material is increased. At this time, for example, the controller 5 increases valve travel of the valve 22 in the raw material supplying mechanism. Furthermore, for example, when the condition of the substance is not normal but if the situation is such that the condition of the substance can become normal by reducing the supply volume of the raw material to be supplied to the continuous reactor 1, the controller 5 causes the raw material supplying mechanism to operate such that the supply volume of the raw material is reduced. At this time, for example, the controller 5 reduces the valve travel of the valve 22 in the raw material supplying mechanism. Thus, the supply volume of the raw material to the continuous reactor 1 can be adjusted such that the continuous reactor 1 produces a normal product.

When the apparatus controlled by the controller 5 includes the detergent supplying mechanism, that is, when the control by the controller 5 includes controlling the operation of the detergent supplying mechanism, the controller 5 can, for example, based on the information acquired by the measuring apparatus 4, and in accordance with the condition of the substance corresponding to the information, cause the detergent supplying mechanism to operate to perform control, such as supplying a detergent to the continuous reactor 1, maintaining the supply of the detergent to the continuous reactor 1, stopping the supply of the detergent to the continuous reactor 1, or maintaining the state where the supply of the detergent to the continuous reactor 1 is stopped. That is, for example, when the condition of the substance corresponding to the information acquired by the measuring apparatus 4 is the normal condition, the controller 5 stops the supply of the detergent to the continuous reactor 1 or maintains the state where the supply of the detergent to the continuous reactor 1 is stopped. At this time, for example, the controller 5 closes the valve 26 in the detergent supplying mechanism or maintains the valve 26 in a closed state. Moreover, for example, when the condition of the substance is not normal and the continuous reactor 1 has to be cleaned, the controller 5 causes the detergent supplying mechanism to operate such that the detergent is supplied to the continuous reactor 1 or the supply of the detergent to the continuous reactor 1 is maintained. At this time, for example, the controller 5 opens the valve 26 in the detergent supplying mechanism or maintains the valve 26 in an open state. Thus, the continuous reactor 1 can be cleaned with a cleaning liquid such that the continuous reactor 1 produces a normal product.

When the apparatus controlled by the controller 5 includes the switching valve 8, that is, control by the controller 5 includes controlling operation of the switching valve 8, the controller 5 can, for example, based on the information acquired by the measuring apparatus 4, and in accordance with the condition of the substance corresponding to the information, cause the switching valve 8 to operate such that the substance sent from the continuous reactor 1 to the guide path 3 is selectively sent from the guide path 3 to the first branch path 6 or the second branch path 7. That is, for example, when the condition of the substance corresponding to the information acquired by the measuring apparatus 4 is the normal condition, the controller 5 switches the switching valve 8 to connect the guide path 3 to the first branch path 6 or maintains the switching valve 8 in a state where the guide path 3 is connected to the first branch path 6. Further, for example, when the condition of the substance is not normal, the controller 5 switches the switching valve 8 to connect the guide path 3 to the second branch path 7 or maintains the switching valve 8 in a state where the guide path 3 is connected to the second branch path 7. Thus, for example, a product which is in the normal condition and a product which is not in the normal condition can be sent to different places. Note that in the present embodiment, the substance sent to the first branch path 6 is sent to the product tank 10, and the substance sent to the second branch path 7 is sent to the waste product tank 11. Thus, for example, the product in the normal condition can be used as a non-defective product, and the product which is not in the normal condition can be discarded as a defective product or can be recycled. Moreover, as shown in an example of specific operation of the continuous production system described later, when the detergent supplying mechanism supplies the detergent to the continuous reactor 1, the controller 5 switches the switching valve 8 to connect the guide path 3 to the second branch path 7 or maintains the switching valve 8 in a state where the guide path 3 is connected to the second branch path 7, and in this case, the detergent sent from the continuous reactor 1 to the guide path 3 can be sent to the second branch path 7, and therefore, the detergent can be sent to a place different from the place for the product in the normal condition.

The apparatus controlled by the controller 5 may include the switching valve 19 disposed at the starting end of the introduction part 16 in the continuous reactor 1. That is, the control by the controller 5 may include controlling operation of the switching valve 19. In this case, when the raw material supplying mechanism supplies the raw material to the continuous reactor 1 and the detergent supplying mechanism does not supply the detergent to the continuous reactor 1, the controller 5 can cause the switching valve 19 to operate such that the introduction part 16 is connected to the supply path 2. Moreover, when the detergent supplying mechanism supplies the detergent to the continuous reactor 1 and the raw material supplying mechanism does not supply the raw material to the continuous reactor 1, the controller 5 can cause the switching valve 19 to operate such that the introduction part 16 is connected to the cleaning flow path 9.

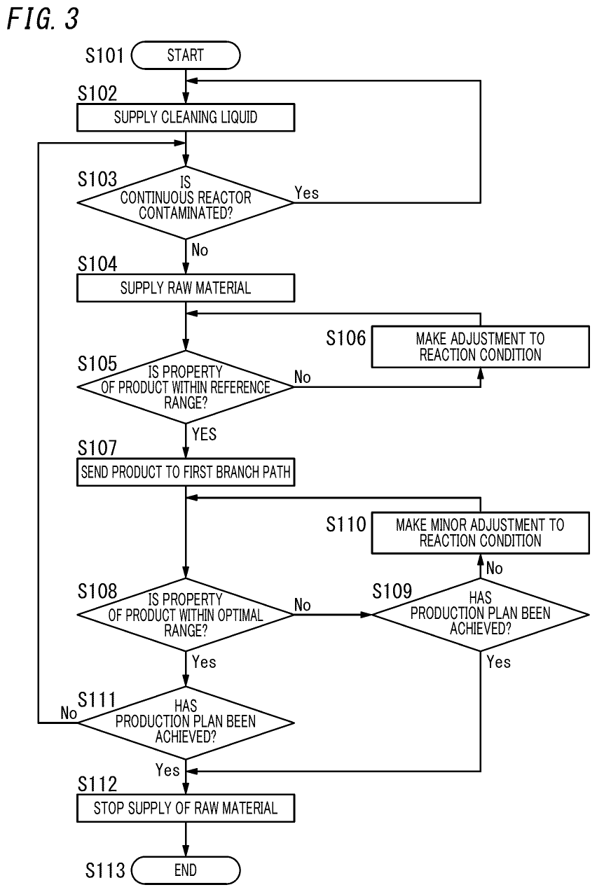

An example of specific operation of the continuous production system will be described with reference to FIG. 3.

When the continuous production system starts operating (S101), the controller 5 first of all performs control of cleaning the continuous reactor 1 with a detergent (S102). Specifically, the controller 5 causes the switching valve 19 disposed at the starting end of the introduction part 16 in the continuous reactor 1 to operate such that the introduction part 16 is connected to the cleaning flow path 9, or the controller 5 maintains the state where the introduction part 16 is connected to the cleaning flow path 9; the controller 5 opens, or maintains the open state of, the valve 26 in the detergent supplying mechanism; and the controller 5 causes the switching valve 8 to operate such that the guide path 3 is connected to the second branch path 7, or the controller 5 maintains the state where the guide path 3 is connected to the second branch path 7. Thus, the detergent is supplied through the detergent flow path to the continuous reactor 1, and the continuous reactor 1 is cleaned. The detergent is further sent from the continuous reactor 1 through the guide path 3 and the second branch path 7 to the waste product tank 11.

Subsequently, the controller 5 determines, based on the information, acquired by the measuring apparatus 4, on the detergent moving in the continuous reactor 1 or in the guide path 3, whether or not the interior of the continuous reactor 1 is contaminated (S103). Specifically, for example, the controller 5 determines, based on the information on the detergent, whether or not the detergent contains an impurity with a certain concentration or higher due to dirt mixed from the continuous reactor 1 with the detergent. If the interior of the continuous reactor 1 is contaminated, the process in S102 is repeated.

If the interior of the continuous reactor 1 is not contaminated, the controller 5 performs control for supplying the raw material to the continuous reactor 1 (S104). Specifically, the controller 5 causes the switching valve 19 disposed at the starting end of the introduction part 16 in the continuous reactor 1 to operate such that the introduction part 16 is connected to the supply path 2, and the controller 5 opens the valve 22 in the supply path 2. Thus, the raw material is supplied through the supply path 2 to the continuous reactor 1, and a product is thus produced in the continuous reactor 1. The product is further sent from the continuous reactor 1 through the guide path 3 and the second branch path 7 to the waste product tank 11.

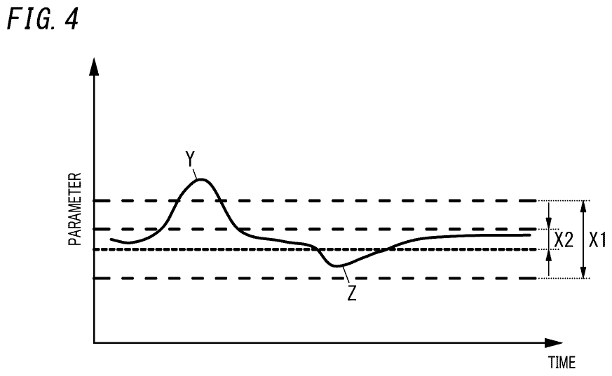

Subsequently, the controller 5 determines, based on the information acquired by the measuring apparatus 4, whether or not the product is in an acceptable condition (S105). Specifically, for example, when the information acquired by the measuring apparatus 4 is represented by a numerical value, whether or not the numerical value is within a set reference range is determined. FIG. 4 shows a time-dependent change in a numerical value (parameter) which is the information acquired by the measuring apparatus 4 when the control by the controller 5 is performed, where reference sign X1 represents the reference range, and reference sign X2 represents an optimal range which will be described later. If the numerical value is within the reference range, the controller 5 determines that the product is in the acceptable condition, and if the numerical value is outside the reference range as shown by reference sign Y in FIG. 4, the controller 5 determines that the product is not in the acceptable condition.

If in the process in S105, the product is not in the acceptable condition (see reference sign Y in FIG. 4), the controller 5 performs control for changing a reaction condition in the continuous reactor 1 (S106). Specifically, for example, the controller 5 performs at least one of control of changing the supply volume of the raw material to the continuous reactor 1 by controlling the raw material supplying mechanism or control of changing the temperature of the continuous reactor 1 by adjusting the temperature adjusting mechanism. Subsequently, the controller 5 repeats the process in S105. Thus, the controller 5 performs control, for example, such that the parameter in FIG. 4 falls within the reference range represented by X1.

If in the process in S105, the product is in the acceptable condition, the controller 5 performs control for sending the product to the first branch path 6 (S107). Specifically, the controller 5 causes the switching valve 8 to operate such that the guide path 3 is connected to the first branch path 6. Thus, the product is sent from the continuous reactor 1 through the guide path 3 to the first branch path 6 and is further sent to, and stored in, the product tank 10.

Subsequently, the controller 5 determines, based on the information acquired by the measuring apparatus 4, whether or not the product is in the optimal condition (S108). Specifically, for example, when the information acquired by the measuring apparatus 4 is represented by a numerical value (parameter), and if the numerical value is in the optimal range, which is in the reference range in the process in S105 and is narrower than the reference range, the controller 5 determines that the product is in the optimal condition, whereas if the numerical value is out of the optimal range, the controller 5 determines that the product is not in the optimal condition. In the example shown in FIG. 4, the reference sign X2 represents the optimal range as described above, and if the numerical value is out of the optimal range as indicated by reference sign Z in FIG. 4, the controller 5 determines that the product is not in the optimal condition.

If in the process in S108, the product is not in the optimal condition, the controller 5 determines whether or not a specified production plan has been achieved (S109). Specifically, for example, it is determined for the product whether or not an integrated amount of the product sent to the first branch path 6 has reached a prescribed amount. For example, the continuous production system is provided with a measurement device, such as an integrating flowmeter configured to measure a integrating flow rate in the first branch path 6, a weight scale configured to measure the weight of the product in the product tank 10, or a liquid-level gauge configured to measurement the location of a liquid level of the product in the product tank 10, and the controller 5 makes a determination based on a measurement result by the measurement device.

If in the process in S109, the production plan has not been achieved, the controller 5 performs control for changing a reaction condition in the continuous reactor 1 (S110). Specifically, for example, the controller 5 performs at least one of control of changing the supply volume of the raw material to the continuous reactor 1 by controlling the raw material supplying mechanism or control of changing the temperature of the continuous reactor 1 by adjusting the temperature adjusting mechanism in a similar manner to the process in S105. Note that the width of the change in the reaction condition is preferably smaller than in the process in S105. Subsequently, the controller 5 repeats the process in S108. Thus, the controller 5 performs control, for example, such that the parameter in FIG. 4 falls within the optimal range represented by X2.

If in the process in S108, the product is in the optimal condition, the controller 5 determines whether or not the specified production plan has achieved (S111). Specifically, the controller 5 performs the same process as the process in S108.

If in the process in S111, the production plan has not been achieved, the controller 5 performs the process in S103 described above. Thus, if the cause of the product being out of the optimal condition is the contamination of the product tank 10, the interior of the product tank 10 is cleaned to eliminate the cause, and thereafter, the production of the product can be restarted.

If in the process in S109 or in the process in S111, the production plan has been achieved, the controller 5 stops the production of the product. Specifically, the controller 5 closes the valve 22 in the supply path 2 to stop supply of the raw material to the continuous reactor 1. Subsequently, the operation of the controller 5 ends (S113).

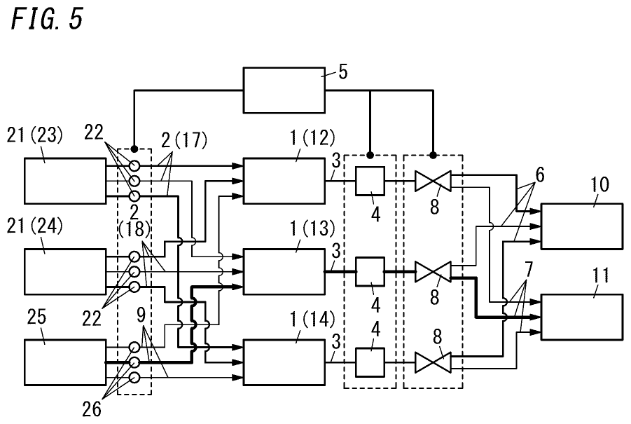

In the present embodiment, at the time of performing the control as described above, the controller 5 can individually perform control of respective apparatuses corresponding to the plurality of continuous reactors 1. That is, the controller 5 can, based on information acquired by the measuring apparatus 4 disposed in each of the continuous reactors 1 or in the guide path 3 connected to the each of the continuous reactors 1, control operation of the temperature adjusting mechanism, the raw material supplying mechanism, the switching valve 8, the detergent supplying mechanism, and the like which correspond to the each of the continuous reactors 1. Therefore, the present embodiment enables the product to be produced while the reaction condition in each of the plurality of continuous reactors 1 is individually controlled. Moreover, for example, as shown in FIG. 5, the detergent may be supplied to the second reactor 13 to clean the second reactor 13 while the raw material is supplied to the first reactor 12 and the third reactor 14 to continue producing the product. Thus, the production of the product can be stably continued.

The information acquired by the measuring apparatus 4 and the determination based on the information by the controller 5 will be described.

As described above, the information acquired by the measuring apparatus 4 is the electric impedance of the substance moving in the continuous reactor 1 or in the guide path 3 or the property of the substance, the property being derived from the electric impedance. The electric impedance of the substance depends on the type, the concentration, and the like of the component included in the substance, and therefore, the condition of the substance can be determined based on the information acquired by the measuring apparatus 4. For example, when the substance is the product, the types of one or more components included in the product and the concentration of each component can be estimated, and whether or not the types, the concentrations, and the like of the components in the product are appropriate can be determined based on the information acquired by the measuring apparatus 4. Therefore, based on the information on the product, the condition of the product produced by using the continuous reactor 1 can be determined, and, in connection therewith, whether or not the reaction condition in the continuous reactor 1 is appropriate can be determined. The component included in the product does not have to be a single component. Also in the case of a mixture including a plurality of components, the determination based on the information acquired by the measuring apparatus 4 can be made. For example, when the product is a mixture including a main product as an object, and a by-product which is a foreign substance, it is possible also to obtain only information on the main product or to simultaneously obtain both the information on the product and information on the by-product. Moreover, when the substance is the detergent, the content of the information acquired by the measuring apparatus 4 is different between when the continuous reactor 1 is satisfactorily cleaned and no contamination substance, or only a small amount of the contamination substance, is included in the detergent and when the continuous reactor 1 is contaminated and a large amount of the contamination substance is included in the detergent. Therefore, whether or not the interior of the continuous reactor 1 is contaminated can be determined based on the information on the detergent. Moreover, also when the substance is the product, the content of the information acquired by the measuring apparatus 4 is different between when the continuous reactor 1 is satisfactorily cleaned and no contamination substance, or only a small amount of the contamination substance, is included in the product and when the continuous reactor 1 is contaminated and a large amount of the contamination substance is included in the product. Therefore, whether or not the interior of the continuous reactor 1 is contaminated can be determined based on the information on the product.

Moreover, in the present embodiment, measuring the electric impedance of the substance which is moving enables the controller 5 to perform control by using a measurement result, and therefore, collecting or once storing the substance for the measurement is no longer necessary. Therefore, when the condition of the substance changes, the controller 5 can perform control in prompt response to the change. Moreover, no restriction is imposed on the substance to be measured, as long as the electric impedance thereof is measurable and the substance can move in the continuous reactor 1 or in the guide path 3. That is, there is no restriction in connection with, for example, optical transparency as in the case of the measurement by, for example, the spectroscopic method. Therefore, various types of substances can be the target of measurement.

In the present embodiment, the information on the substance may be a measured value of the electric impedance of the substance. In this case, the information of the substance is, for example, a waveform showing the frequency dependency of a measured value of the electric impedance at one specific measurement frequency, measured values of electric impedances at two or more specific measurement frequencies, or a measured value of the electric impedance measured while the measurement frequency is swept. The information on the substance may be a value, such as the difference between measured values of electric impedances at two or more specific measurement frequencies, derived by a specific operation method from the measured values of the electric impedances.

When the information on the substance is the property of the substance derived from the electric impedance of the substance, the information on the substance is at least one selected from the group consisting of, for example, a phase shift between a current and a voltage, electrical conductivity, permittivity, complex electrical conductivity, complex permittivity, a permittivity spectrum, a dielectric relaxation frequency of the substrate, and a characteristic value calculated from at least one selected from the group consisting of, for example, the electric impedance, the phase shift, the electrical conductivity, the permittivity, the complex electrical conductivity, the complex permittivity, the permittivity spectrum, and the dielectric relaxation frequency.

When the information on the substance is the phase shift between the current and the voltage, the electrical conductivity, the permittivity, the complex electrical conductivity, the complex permittivity, or the like (hereinafter also referred to as the electrical conductivity or the like) of the substance, the information on the substance may be, for example, the electrical conductivity or the like at one specific measurement frequency or electric conductivities or the like at two or more specific measurement frequencies.

When the information on the substance is the phase shift, the phase shift is a phase shift between a voltage across electrodes and a current flowing between the electrodes when an alternating-current voltage is applied across the electrodes, or a phase shift between a current flowing between electrodes and a voltage across the electrodes when an alternate current is allowed to flow between the electrodes.

When the information on the substance is the permittivity spectrum, the permittivity spectrum means the frequency dependency of the permittivity. The permittivity spectrum may be a complex permittivity spectrum representing the frequency dependency of each of the real part and the imaginary part of the complex permittivity.

When the information on the substance is the dielectric relaxation frequency obtained from the permittivity spectrum, in particular, whether or not an impurity, such as a contamination substance, is included in the substance and the concentration and the like of the impurity can easily be determined based on the dielectric relaxation frequency.

When the information on the substance is the characteristic value described above, the characteristic value is a value, such as the difference in permittivity between two or more specific measurement frequencies, derived by a specific operation method from at least one selected from the group consisting of the electric impedance and the property derived from the electric impedance. The use of such a characteristic value is, for example, effective in, for example, a case where no dielectric relaxation frequency is obtained (i.e., a case where no maximum peak is observed in the imaginary part of the complex permittivity).

When the information on the substance is represented by a numerical value, the controller 5 checks whether or not the numerical value is within a specified range, and the controller 5 can perform control according to a check result. For example, the control as shown in FIG. 5 in the description of the operation of the controller 5 described above can be performed.

When the information on the substance is, for example, the waveform of the permittivity spectrum or the like, the controller 5 may perform, for example, pattern recognition between the waveform which is the information on the substance and a prescribed waveform, determine whether or not the similarity between both the waveforms is greater than or equal to a fixed value, and perform control based on a determination result.

The measuring apparatus 4 may acquire the information on the substance as a tomographic image. That is, the controller 5 may perform control based on information configured as the tomographic image. The tomographic image is obtained, for example, as an image at a specific cross section intersecting the travel direction of the substance in the continuous reactor 1 or in the guide path 3. Note that the tomographic image may be obtained as a three-dimensional image corresponding to a portion in the continuous reactor 1 or in the guide path 3. Each of pixels in the tomographic image has a pixel value of, for example, the electric impedance, the phase shift, the electrical conductivity, the permittivity, the complex electrical conductivity, the complex permittivity, the dielectric relaxation frequency, or the characteristic value described above.

When the information on the substance is the tomographic image, the controller 5 uses, for example, image processing technology as necessary, and based on the presence or absence of a pixel having a pixel value falling out of a fixed range, the number of pixels having the pixel value falling out of the fixed range, the size of a collection of the pixels having the pixel value falling out of the fixed range, the location of the collection of the pixels having the pixel value falling out of the fixed range, the uniformity of distribution of pixels having the pixel value falling out of the fixed range, or the like in the tomographic image, the controller 5 can determine the condition of the substance and can perform control according to a determination result. Therefore, control can be performed based on the distribution of properties in the substance, a local abnormality in the substance, or the like. For example, when the information on the substance is the tomographic image, in particular, the presence of a contamination substance can be easily detected, and control of, for example, cleaning the continuous reactor 1 can be promptly performed.

When the information on the substance is the tomographic image, the measuring apparatus 4 includes, for example, an electric impedance tomography measuring apparatus or a dielectric relaxation tomography measuring apparatus.

In the present embodiment, a specific algorithm and the like for the determination based on the information and a decision on contents of control corresponding to the determination result in the controller 5 can be arbitrarily specified by a designer, a user, or the like of the continuous production system. The algorithm and the like may be a learned model resulting from machine learning.

In the present embodiment, the continuous production system may further include a measuring apparatus (hereinafter referred to as a second measuring apparatus) configured to acquire, as the information on the substance, properties other than the electric impedance or the property derived from the electric impedance. In this case, the controller 5 can perform control by using also the information acquired by the second measuring apparatus. The second measuring apparatus may include an arbitrary sensor such as a temperature sensor, a humidity sensor, a pressure sensor, a flow rate sensor, a bulk sensor, a weight sensor, an area sensor, or a sound sensor.

In the present embodiment, the raw material and the product are not particularly limited as long as they have flowability. For example, the raw material and the product may be liquid, but as long as they have flowability, they may include a solid substance such as powder. Examples of the product include medicinal products, chemical products, and cosmetics, but the product is not limited to these examples.

In the present embodiment, the product produced by using the continuous reactor may be an end product or an intermediate product (semi-product). When the product is the intermediate product, the product sent to the guide path 3 is not sent to the product tank 10 but may be sent to, for example, a reactor other than the continuous reactor, and the reactor may produce the end product.

In the present embodiment, the number of the controller 5 does not have to be one. For example, when there are a plurality of apparatuses controlled by the controller 5, the continuous production system may include a plurality of controllers 5 corresponding to the plurality of apparatuses on a one-to-one basis. Moreover, a connection between the controller 5 and the measuring apparatus 4 and a connection between the controller 5 and the apparatus controlled by the controller 5 may be implemented by a direct wired or wireless connection, or via a network such as a local area network or a wide area network. The controller 5 may include a plurality of control devices, and the plurality of control devices may be incorporated into a distributed control system (DCS). That is, a control device may be provided for each apparatus included in the continuous production system, and the control devices may be connected to each other via a network and have a mutual communication and management mechanism.

As can be seen from the embodiment, a continuous production system of a first aspect of the present disclosure includes a continuous reactor (1), a supply path (2) connected to the continuous reactor (1), a guide path (3) connected to the continuous reactor (1), a measuring apparatus (4) configured to acquire information on a substance moving in the continuous reactor (1) or in the guide path (3), and a controller (5) configured to perform control based on the information. The information is electric impedance of the substance or a property of the substance, the property being derived from the electric impedance.

The first aspect enables the information on the substance moving in the continuous reactor (1) or in the guide path (3) to be promptly acquired and enables the controller (5) to perform control based on the information.

In a second aspect of the present disclosure referring to the first aspect, the property is at least one selected from the group consisting of: a phase shift; electrical conductivity; permittivity; complex electrical conductivity; complex permittivity; a permittivity spectrum; a dielectric relaxation frequency; and a characteristic value calculated from at least one selected from the group consisting of the electric impedance, the phase shift, the electrical conductivity, the permittivity, the complex electrical conductivity, the complex permittivity, the permittivity spectrum, and the dielectric relaxation frequency.

The second aspect enables control based on the property of the substance to be performed.

In a third aspect of the present disclosure referring to the first or second aspect, the measuring apparatus (4) is configured to acquire the information as a tomographic image.

The third aspect enables control based on, for example, distribution of properties in the substance or a local abnormality in the substance to be performed.

A fourth aspect of the present disclosure referring to any one of the first to third aspects further includes a temperature adjusting mechanism configured to adjust a temperature of the continuous reactor (1), wherein the control by the controller (5) includes controlling operation of the temperature adjusting mechanism.

The fourth aspect enables the temperature of the continuous reactor (1) to be controlled such that a reaction condition in the continuous reactor (1) is appropriate.

A fifth aspect of the present disclosure referring to any one of the first to fourth aspects further includes a raw material supplying mechanism configured to supply a raw material through the supply path (2) to the continuous reactor (1), wherein the control by the controller (5) includes controlling operation of the raw material supplying mechanism.

The fifth aspect enables supply of the raw material to the continuous reactor (1) to be controlled such that the reaction condition in the continuous reactor (1) is appropriate.

A sixth aspect of the present disclosure referring to any one of the first to fifth aspects further includes: a first branch path (6) and a second branch path (7) which are connected to a terminating end of the guide path (3); and a switching valve (8) configured to selectively connect the guide path (3) to the first branch path (6) or the second branch path (7), wherein the control by the controller (5) includes controlling operation of the switching valve (8).

The sixth aspect enables a destination to which the substance is to be sent to be changed depending on the condition of the substance.

A seventh aspect of the present disclosure referring to any one of the first to sixth aspects further includes: a cleaning flow path (9) connected to the continuous reactor (1); and a detergent supplying mechanism configured to supply a detergent through the cleaning flow path (9) to the continuous reactor (1), wherein the control by the controller (5) includes controlling operation of the detergent supplying mechanism.

The seventh aspect enables the continuous reactor (1) to be cleaned depending on the condition of the substance.

### REFERENCE SIGNS LIST

1 Continuous Reactor
2 Supply Path
3 Guide Path
4 Measuring Apparatus
5 Controller
6 First Branch Path
7 Second Branch Path
8 Switching Valve
9 Cleaning Flow Path

1. A continuous production system comprising:
a continuous reactor;
a supply path connected to the continuous reactor;
a guide path connected to the continuous reactor;
a measuring apparatus configured to acquire information on a substance moving in the continuous reactor or in the guide path; and
a controller configured to perform control based on the information,
the information being electric impedance of the substance or a property of the substance, the property being derived from the electric impedance.

2. The continuous production system of claim 1, wherein
the property is at least one selected from the group consisting of: a phase shift between a current and a voltage; electrical conductivity; permittivity; complex electrical conductivity; complex permittivity; a permittivity spectrum; a dielectric relaxation frequency; and a characteristic value calculated from at least one selected from the group consisting of the electric impedance, the phase shift, the electrical conductivity, the permittivity, the complex electrical conductivity, the complex permittivity, the permittivity spectrum, and the dielectric relaxation frequency.

3. The continuous production system of claim 1, wherein
the measuring apparatus is configured to acquire the information as a tomographic image.

4. The continuous production system of claim 1, further comprising a temperature adjusting mechanism configured to adjust a temperature of the continuous reactor, wherein
the control by the controller includes controlling operation of the temperature adjusting mechanism.

5. The continuous production system of claim 1, further comprising a raw material supplying mechanism configured to supply a raw material through the supply path to the continuous reactor, wherein
the control by the controller includes controlling operation of the raw material supplying mechanism.

6. The continuous production system of claim 1, further comprising:
a first branch path and a second branch path which are connected to a terminating end of the guide path; and
a switching valve configured to selectively connect the guide path to the first branch path or the second branch path, wherein
the control by the controller includes controlling operation of the switching valve.

7. The continuous production system of claim 1, further comprising:
a cleaning flow path connected to the continuous reactor; and
a detergent supplying mechanism configured to supply a detergent through the cleaning flow path to the continuous reactor, wherein
the control by the controller includes controlling operation of the detergent supplying mechanism.
